(19) United States
(12) Patent Application Publication
(10) Pub. No.: US 2016/0355386 A1
(43) Pub. Date: Dec. 8, 2016

(54) DOUBLE LIFT FOR MOBILITY DEVICE REPAIR

(71) Applicant: Janco Industries, Inc., Sully, IA (US)

(72) Inventor: Joel M Mansen, Sully, IA (US)

(21) Appl. No.: 15/172,150

(22) Filed: Jun. 3, 2016

Related U.S. Application Data
(60) Provisional application No. 62/169,571, filed on Jun. 2, 2015.

(51) Int. Cl. B66F 7/06

(52) U.S. Cl. CPC B66F 7/0675

(57) ABSTRACT

A wheel chair lift includes a primary lift platform and a secondary lift platform. The primary lift platform is attached to a lifting mechanism to raise and lower the primary lift platform relative to the floor. The secondary lift platform is attached to a second lift mechanism used to raise and lower the secondary lift platform relative to the primary lift platform. The secondary lift platform can be used to elevate a mobility device off of the primary lifting device.

### CROSS REFERENCE TO RELATED APPLICATION

This application claims priority to U.S. Provisional Patent Application No. 62/169,571 filed Jun. 2, 2015, the entire contents of which are hereby incorporated by reference.

### FIELD OF INVENTION

This invention relates generally to lifting devices, and more particularly to lifting devices used in repair and maintenance of wheeled devices.

### BACKGROUND OF THE INVENTION

Motorized wheelchairs and scooters have become prevalent. These mobility devices permit improved mobility to a large portion of the population who may otherwise struggle to move themselves around as desired. These chairs and scooters typically use an electric motor powered by a rechargeable battery or batteries. It is not uncommon for such mobility devices to weigh between 150-300 pounds or more. The components for these wheelchairs and scooters require periodic maintenance and occasional repair. It is desirable to use a lift to raise the mobility device to a height where it can be more ergonomically accessed. Sometimes it is acceptable, and even preferable, to have the device supported by its wheels when in the lifted position. Other times, such as for the replacement of wheels, it would be desirable to have the weight removed from the wheels of the mobility device when it is in the lifted position.

### SUMMARY OF THE MENTION

The present invention in one embodiment is an improved lift for working on wheeled mobility device 18s such as wheelchairs or scooters. The improved lift of the present invention includes a primary platform that is moved between a lowered loading position and elevated working positions using a lift mechanism, such as a scissor lift. A secondary platform is recessed within the primary platform and has its own lift mechanism. In operation, the primary lift can be raised to a desired working height so that a user can ergonomically access the mobility device. If it is desired to remove the weight of the mobility device from the wheels, for example so that the wheels of the mobility device can be replaced, the secondary platform can be raised to lift the mobility device off of the surface of the primary platform.

According to one embodiment the present invention is directed to a lift for elevating a wheeled mobility device to a convenient height for performing work on the mobility device. The lift includes a primary platform that has a generally upwardly facing support surface. A primary lifting mechanism is attached to the primary platform for raising the primary platform to a working height that is convenient for working on a wheeled mobility cart supported on the primary platform support surface and for lowering the primary platform to a loading height that is convenient for loading the wheeled mobility cart onto the primary platform support surface. A secondary platform is recessed in the primary platform. The secondary platform has a secondary support surface. A secondary lifting mechanism is connected to the secondary platform for raising the secondary platform to an extended raised position that lifts the wheeled mobility cart off of the primary support surface and for lowering the secondary platform to a lowered position wherein the secondary support surface is low enough to permit the wheeled mobility device to be rolled on to the primary support surface.

### BRIEF DESCRIPTION OF THE DRAWINGS

FIG. 1 is a side view of a double lift according to one embodiment of the present invention, with the lift in a fully lowered loading position.

FIG. 2 is a perspective view of the double lift of FIG. 1 with a wheelchair being loaded onto the primary lift platform.

FIG. 3 is a perspective view from ground level showing the double lift and wheelchair of FIG. 2 with the primary lift platform 14 partially raised.

FIG. 4 is a front elevation view of the double lift and wheelchair of FIG. 3 with the primary platform 14 in a fully raised working position.

FIG. 5 is a right side elevation view of the double lift and wheelchair of FIG. 4,

FIG. 6 is partial side elevation view of the double lift and wheelchair of FIG. 5 showing the secondary platform in a raised working position.

FIG. 7 shows a partial elevation view of the double lift of FIG. 6 with the secondary platform in a raised position and the wheelchair removed.

FIG. 8 is a perspective view of the double lift of FIG. 7 showing the upper surface of the secondary lift.

FIG. 9 is an isometric view of the lift platforms according to one embodiment of the present invention showing the secondary platform in a raised position relative to the primary platform.

FIG. 10 is an isometric view of the underside of the lift platforms of FIG. 9.

### DETAILED DESCRIPTION OF PREFERRED EMBODIMENTS

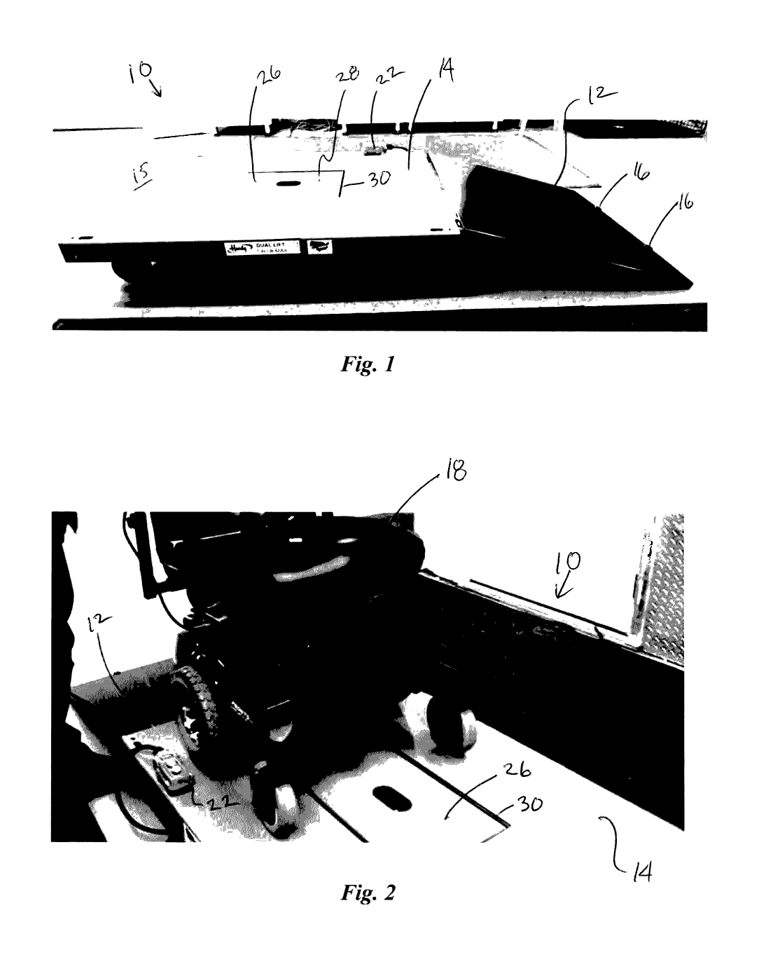

FIG. 1 is a photographic side view of a double lift 10 according to one embodiment of the present invention, with the lift in a fully lowered loading position. At one side of the double lift 10 a ramp 12 angles between the floor and a primary platform 14. The ramp 12 is hingedly attached to the primary platform 14. Accordingly, the ramp 12 provides a surface to facilitate rolling a wheeled mobility device 18 from the floor onto the primary platform 14 or from the platform to the floor. At the free end of the ramp 12, the ramp 12 may be provided with rollers or wheels 16 to engage the floor, so that as the primary platform 14 is raised and lowered, the free end of the ramp 12 can move along the floor without dragging or skidding. In this way, the ramp 12 can be self-deploying as the primary platform 14 is raised and lowered.

The primary platform 14 provides a flat upward facing support surface 15 on to which a wheeled mobility device 18 18 can be rolled. A lift mechanism 20, such as a scissor lift as described below, may be used to lift the primary platform 14 to a convenient height for performing repairs or maintenance on the wheeled mobility device 18 18. A control 22 may be provided to operate an electric motor 24 to raise and lower the primary platform 14. Alternatively, the lift mechanism may be operated by manual force. Centrally located and recessed within the primary platform 14 is a secondary platform 26. The secondary platform 26 also includes a flat upward facing surface 28 that is flush with the upward support surface of the primary platform 14 when the secondary platform is in the lowered position shown in FIG. 1. An opening 30 is centrally provided within the support surface 28 of the secondary platform 26. This opening 30 facilitates hardware and other projections that may extend downward from the lower portion of the wheeled mobility device 18 18.

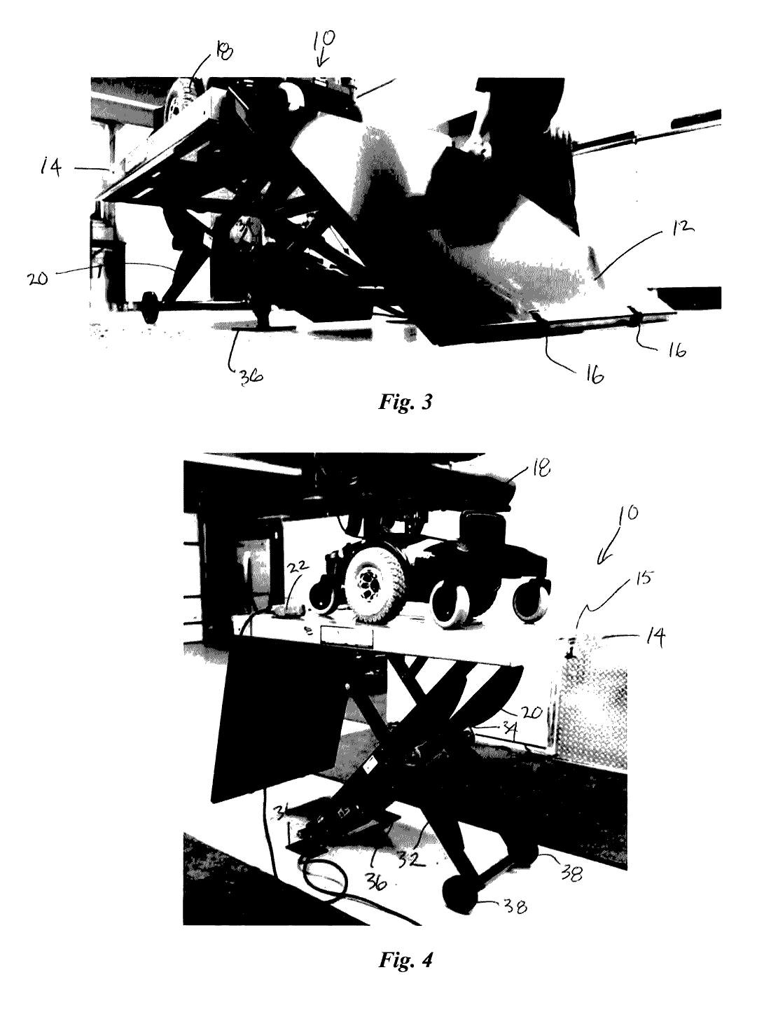

FIG. 2 shows the double lift 10 of FIG. 1 with a wheelchair 18 being loaded onto the primary lift platform 14. The wheelchair 18 is able to roll up the ramp 12 onto the primary lift platform 14. Once the wheelchair 18 is securely on the primary platform 14 the controls 22 may be used to activate the lift mechanism 20 to lift the primary platform 14 toward an elevated position that is convenient for working on the wheelchair 18. FIG. 3 shows the double lift 10 and wheelchair 18 of FIG. 2 with the primary lift platform 14 partially raised toward a working position. The wheels 16 on the free end of the ramp 12 allow the ramp 12 to fold toward the double lift 10 without significant resistance from the floor.

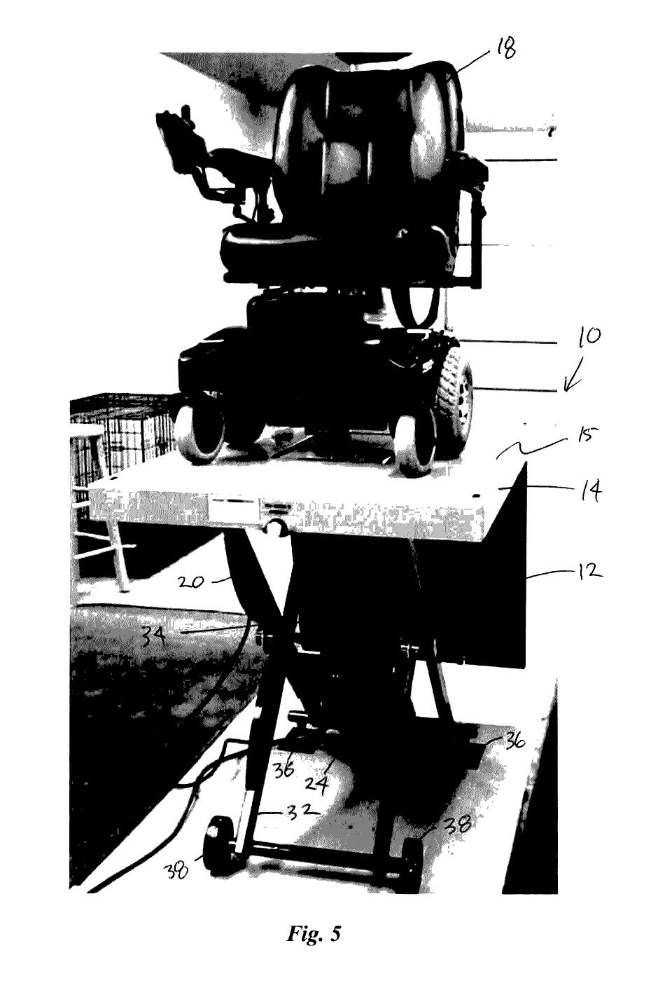

FIGS. 4 and 5 show the double lift 10 and wheelchair 18 with the primary platform 14 in a fully raised working position. The controls 22 may be set to automatically stop the lift at a maximum height, for example with a limit switch. Alternatively, the user may stop the lift 10 at a desired height lower than the maximum height. The lift mechanism 20 of the shown embodiment is a scissor lift 32. A screw jack 34 connected to an electric motor 24 provides the force to draw the lower portion of the legs together to raise the primary platform 14, or to expand the free ends of the legs to lower the primary platform 14. One set of the legs (lower end nearest ramp 12) include feet 36 that remain stationary supported on the floor. The other set of legs include wheels 38 that roll along the floor as the legs scissor relative to each other. Other lift mechanisms may be used to lift the primary platform 14 while still realizing the primary advantages of the present invention.

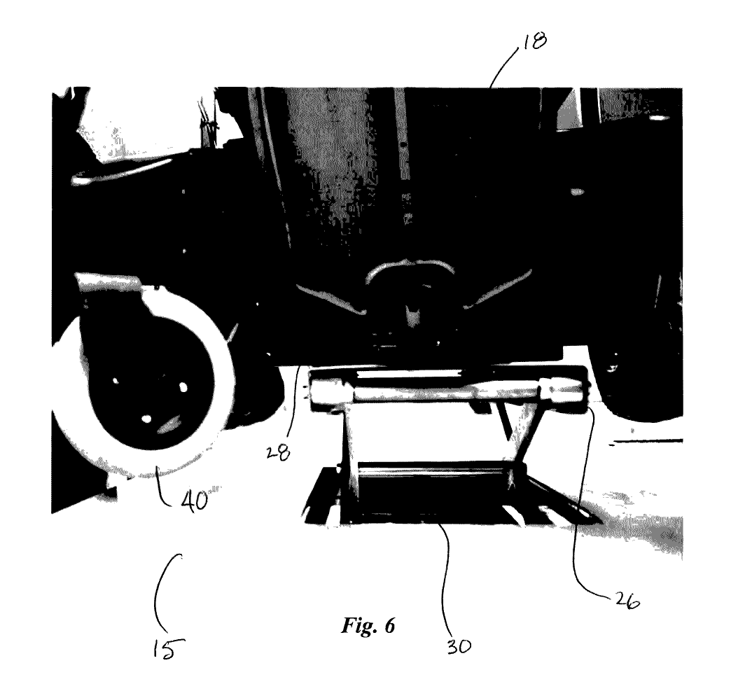

FIG. 6 shows the secondary platform 26 in a raised working position wherein the support surface 28 of the secondary platform 26 supports the wheelchair 18 with the wheelchair's wheels 40 off the support surface 15 of the primary platform 14. In the position of FIG. 6, the weight of the wheelchair 18 is supported by the support surface 28 of the secondary platform 26, such that the weight is not on the wheels 40. This permits a user to perform maintenance on the wheels 40, or replace them with new wheels.

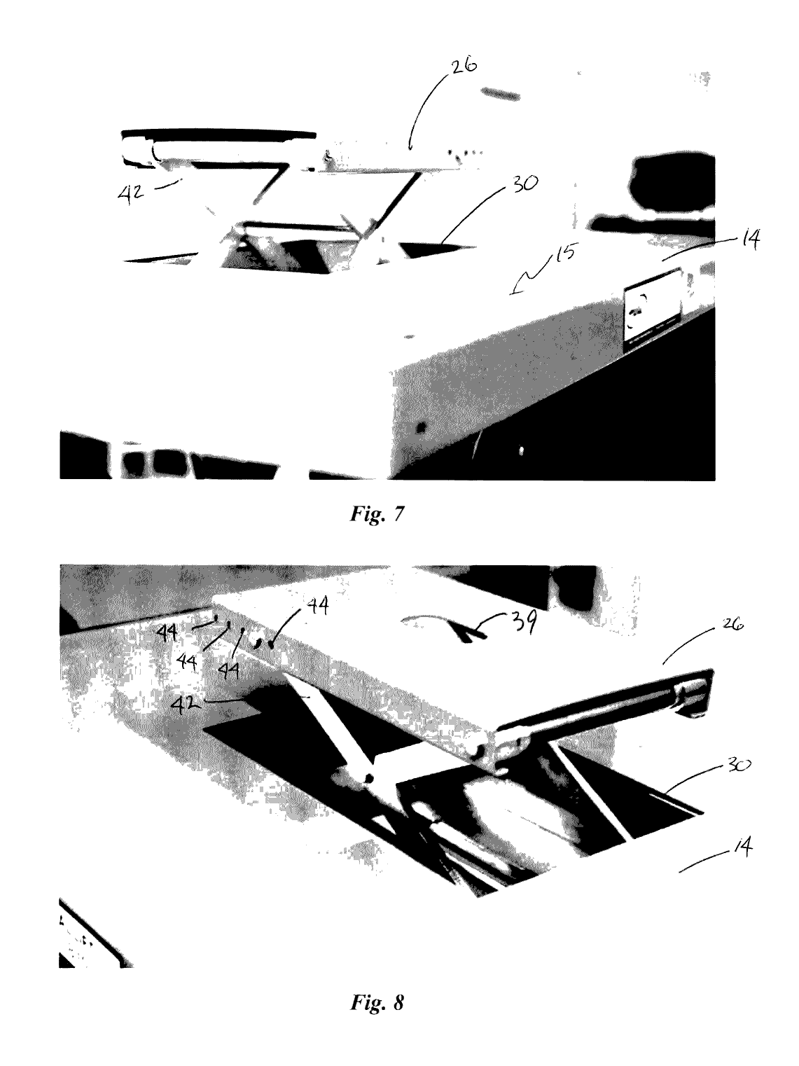

FIGS. 7 and 8 show the double lift 10 with the secondary platform 26 in a raised position and the wheelchair removed to show the lift mechanism 42 for the secondary platform 26. In the embodiment shown the lift mechanism 42 for the secondary platform is a second scissor lift. As best seen in FIG. 8, the maximum height of the secondary lift 42 can be adjusted by changing the mounting location of one set of scissor legs in one of several holes 44 in the secondary platform 26. The upper surface 28 of the secondary platform 26 includes an opening 39 that can accommodate projections from the bottom surface of the mobility device 18.

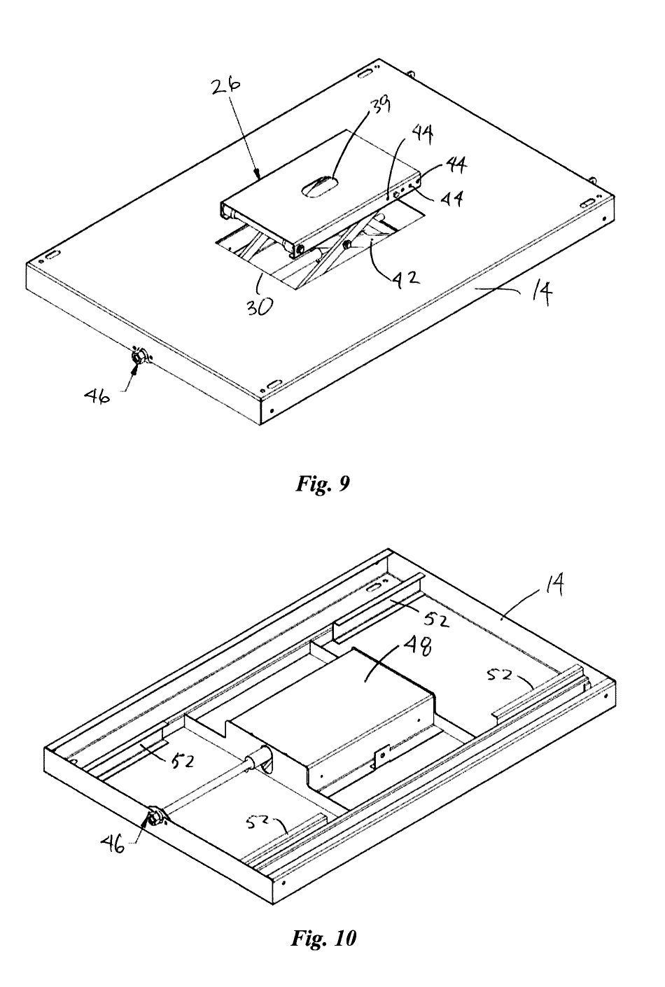

Additional details of the secondary lift 42 can be seen in FIGS. 9 and 10. As seen in FIG. 9, the secondary lift 42 can be raised and lowered by manually adjusting a scissor jack drive 46 using a wrench, for example a socket attached to a ratchet wrench. FIG. 10 shows the underside of the primary platform 14. A housing 48 is attached to the underside of the primary platform 14. The housing 48 provides support for the secondary lift 42. One end of the housing 48 has an opening 50 for the scissor jack drive. Tracks 52 are also mounted on the underside of the primary platform 14 for connecting to the lifting mechanism.

In addition, numerous various, adjustments, substitutions, and the like may be incorporated into the present invention and are intended to be considered a part of the present invention. It should be understood that additional changes and modifications to the embodiment shown and described herein will be apparent to those skilled in the art. Such changes and modifications may be made without departing from the spirit and scope of the invention, and without diminishing its advantages. It is intended, therefore, that such changes and modifications be covered by the embodiments of the invention.

I claim:

1. A lift for elevating a wheeled mobility device 18 to a convenient height for performing work on the mobility device, the lift comprising:
a primary platform 14 having a generally upwardly facing support surface;
a primary lifting mechanism for raising the primary platform 14 to a working height that is convenient for working on a wheeled mobility cart supported on the primary platform 14 support surface and lowering the primary platform 14 to a loading height that is convenient for loading the wheeled mobility cart onto the primary platform 14 support surface;
a secondary platform recessed in the primary platform 14, the secondary platform having a secondary support surface; and
a secondary lifting mechanism for raising the secondary platform to an extended raised position that lifts the wheeled mobility cart off of the primary support surface and for lowering the secondary platform to a lowered position wherein the secondary support surface is low enough to permit the wheeled mobility device 18 to be rolled on to the primary support surface.
